(19) United States
(12) Patent Application Publication
(10) Pub. No.: US 2009/0036141 A1
(43) Pub. Date: Feb. 5, 2009

(54) Mobile advertisement selection method

(76) Inventor: Albert C. Pollard, White Stone, VA (US)

Correspondence Address: Albert Pollard, PO Box 266, Irvington, VA, 22480, US

(21) Appl. No.: 11/497,102

(22) Filed: Aug. 1, 2006

(51) Int. Cl. H04W 24/00

(52) U.S. Cl. 455/456.1

(57) ABSTRACT

A method for specifying and selecting a message to be displayed on a mobile advertising unit wherein specifying the message comprises specifying a begin location for the message, specifying the message to be displayed, and specifying an end location for the message. The message is displayed only if the mobile advertising unit arrives at the begin location before it arrives at the end location.

### BACKGROUND OF THE INVENTION

1. Field of Invention

This invention relates to a method by which an advertiser designates an advertisement to be displayed based on the geographical location of the mobile unit displaying the advertisement.

2. Prior Art

Before proceeding with further discussion, it is in order to point out language common in patent claims, which may have a different meaning to a lay person. It is common to use language such as “A first lever is coupled to a second lever wherein . . . ” First and second are ordinal numbers. By strict definition ordinal numbers specify an order or sequence. Cardinal numbers are rarely used to specify parts. That is it is rare to see “Lever number one is coupled to lever number two wherein . . . ” Thus it must be concluded that unless the specification supports the use of ordinal numbers as specifying a sequence the use of ordinal numbers is simply a means of distinguishing various parts. In this patent application the use of ordinal numbers is used to specifically point out a sequence.

Several mobile information conveying devices are disclosed in the patent records. Specifically U.S. Pat. No. 6,545,596 to Moon, discloses advertising message selection based on the physical location of the mobile advertising apparatus. It is important to note that Moon uses “first” and “second” repeatedly in the claims, however these words do not appear in the specification or abstract. It must be concluded that the drafter of the claims used the common practice of identifying entities by using the terms “first” and “second” to have the same meaning as “number one” or “number two”.

The Moon patent nowhere discloses multiple advertising messages by the same advertiser. Nor does he disclose that the sequence of messages is to be displayed is specified. Moon does not disclose or suggest that an advertising message should not be displayed if the mobile advertising apparatus arrives a second physical location before it arrives at a first physical location.

U.S. Pat. No. 5,938,721 to Dussell discloses a system that is similar to that which is disclosed by the Moon patent. Specifically, that messages displayed on a PDA are based on the physical location of the PDA. For the Dussell system to work properly, all messages that fall within the location criteria specified must be displayed. In the present invention, messages are not displayed unless the sequence of locations of the mobile advertising media meet the advertiser's specifications. Dussell does not disclose or suggest that an advertising message should not be displayed if the mobile advertising apparatus arrives at a particular physical location before it arrives at another physical location.

U.S. Pat. No. 6,236,330 to Cohen discloses a mobile display system wherein advertising messages to be displayed are determined by the location of the mobile display system as well as time of day and other criteria. However, Cohen does not disclose or suggest that an advertising message should not be displayed if the mobile advertising apparatus arrives a second physical location before it arrives at a first physical location.

U.S. Pat. No. 6,898,517 to Froeberg discloses a method of selecting a message to be displayed by use of a compass. This patent focuses on the advertiser specifying the direction of travel of the mobile advertising unit. The limitations of this method of message selection is that the roadway on which the mobile advertisement media travels may be twisted and curved thus limiting the value of direction as a selection criteria for selecting the message to be displayed. The present invention does not use a compass as a means of determining a message to be displayed. Froeberg does not disclose how the message is to be terminated.

### SUMMARY OF THE INVENTION

The present invention is a method by which an advertiser may specify the sequence in which one or more messages advertising a product or service are to be presented on a mobile location dependent advertising medium. Specifically the advertising medium is a changeable display on a vehicle such as a truck or bus. It is desirable for an advertiser to specify the sequence in which his messages are displayed. For example, suppose the advertiser wishes to display a classic Burma-Shave series slogan of messages of the 1950's. Burma-Shave was a shaving cream that was advertised through a series of small signs. The signs touted how handsome and how smooth the shave is through a series such as “Burma-Shave” followed by “Was such a boom” followed by “They passed the bride” followed by “And kissed the groom.” It would be of little value to the advertiser if the messages were displayed in any other order. Thus the sequence in which these messages are displayed is extremely important to the advertiser. The location alone of the mobile sign is not sufficient to determine effective messages to be displayed. Furthermore, if the messages cannot be displayed in the specified sequence, the messages should not be displayed at all. The mobile sign can be thought of as virtual signs as if they were on the side of the road.

### BRIEF DESCRIPTION OF THE DRAWINGS

FIG. 1 illustrates a system incorporating the present invention.

FIGS. 2A, 2B, 2C, 2D and 2E show a computer monitor illustrating the preferred method an advertiser may use to specify how his message is to be displayed.

### DETAILED DESCRIPTION

The following description of the advertising selection method of the present invention gives details of the novel features of the invention. Computer programs and hardware designs are not discussed in detail because these details are within the skills of practitioners of these arts and are disclosed in the prior art.

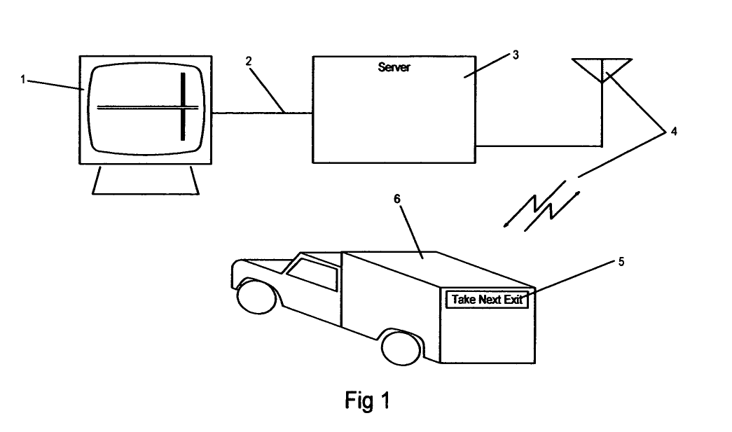

Referring to FIG. 1, the present invention is comprised of a mobile advertising display 5 on a vehicle 6, a locating device associated with the display that determines the physical location of the display is incorporated in the display 5, a communications link 4 between a server and the mobile advertising display, and a web page 1 linked via communications link 2 to a server 3. These elements of the system are well known and well documented in the above referenced patents and are available to a designer wishing to implement the present invention. Thus the following discussion will focus on the novel features of the present invention.

The principal novel concept of the present invention is that the location of a mobile advertising display alone is insufficient criteria for optimal selection of advertising message sequences. Just as in the Burma-Shave example given above, The advertiser wishes the viewer to see the signs just as he would see the signs if they were on the side of the road. The reader should think of the mobile messages as if they were billboards viewable from a great distance but not necessarily viewable around a sharp curve in the road, just as a real billboard is not visible around a sharp curve in the road. For example, an advertiser may wish to display so the viewer sees the following “Watch for directions to McDonalds” and subsequently sees the message “McDonalds next intersection”, just as he would if the messages were on signs on the side of the road. The advertiser would not want the mobile advertising display to show “McDonalds next intersection”, and then show “Watch for directions to McDonalds”. In the case of signs on the side of the road there are two signs, one for each part of the message. With the mobile sign both messages must be displayed on the same sign, thus to emulate on the mobile display the viewing of two signs, the mobile display must show the signs in the sequence they would be viewed if they were signs on the side of the road. Therefore it is necessary to specify the sequence of messages to be displayed. If the messages cannot be displayed in this sequence then the messages should not be displayed at all. In other words, the advertiser specifies a begin location to display the first message: “Watch for directions to McDonalds” and at a second location display the second message: “McDonalds next intersection” with the further stipulation that the second message is not to be displayed unless the first message is first displayed regardless of the location of the mobile advertising medium. Thus the concept is that if the messages cannot be displayed in the order specified then don't display the messages at all. Of course there may be other criteria associated with the display of the message such as don't display the message at times other than between 12:00 noon and 1:00 PM.

Another situation is a specification that a message have a section of road on which a message is displayed. This section of road is defined by a location where the message is to begin to be displayed and a location at which it is to be terminated and if it cannot be first displayed at the begin location and terminated at end location, then do not display the message at all. For example, the advertiser may wish to display the message “Next McDonalds in 30 miles”. He may wish the message to begin to be displayed at location ‘A’ and be terminated at location ‘B’. The advertiser would then specify at location ‘A’ begin the message “Next McDonalds in 30 miles” and terminate the message at location ‘B’.

Another way to think of the mobile display as a virtual sign is to think of the vehicle carrying the mobile sign a projector screen, and location A of the illustration above is the location of projector projecting a message onto the screen of the vehicle. Think of the projector screen as being on all sides of the vehicle. Regardless of the orientation of the vehicle the message is displayed on the vehicle. Thus the mobile sign may be on the front, side, or rear of the vehicle. The main point is one does not see the image projected on the screen of the vehicle unless he is on the same side of the vehicle as the projector. When the vehicle passes location A, if it has not already passed location B, it is if the projector is turned on and the message is displayed on the projector screen on the truck. If the mobile advertising unit arrives at location ‘B’ where the message is to be terminated before it arrives at location ‘A’ where the message is to be begun, the message would not be displayed at all. Thus it is as if the projector is not turned if the mobile sign arrives at location B before it arrives at location A. However if the vehicle passe location A, not having gone through location B, the projector is turned on so that the message is viewable on the screen of the vehicle.

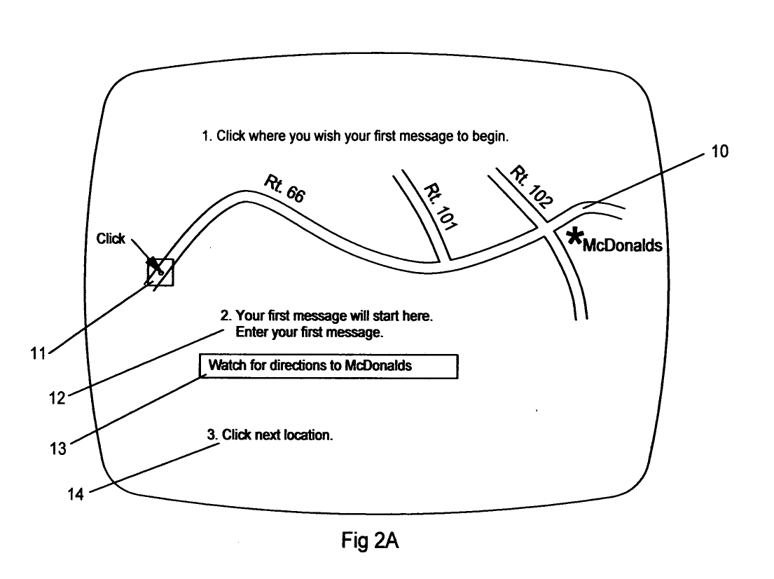

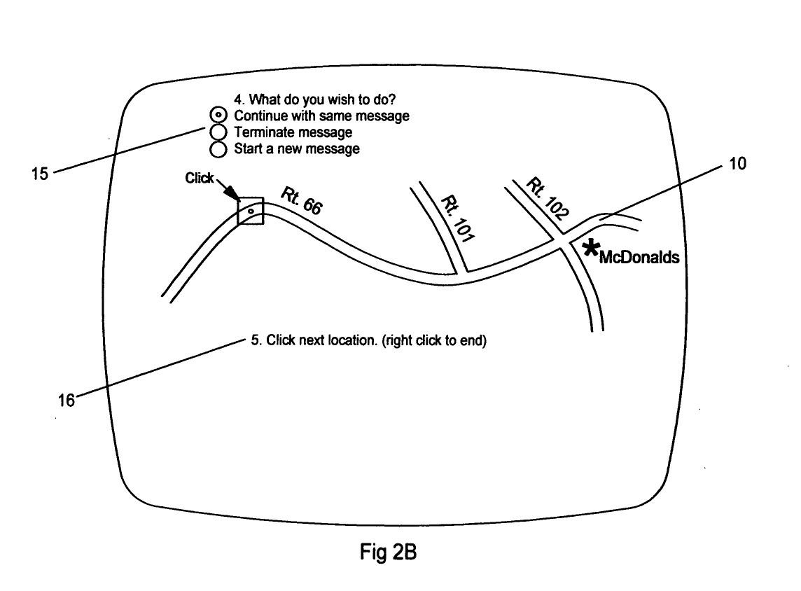

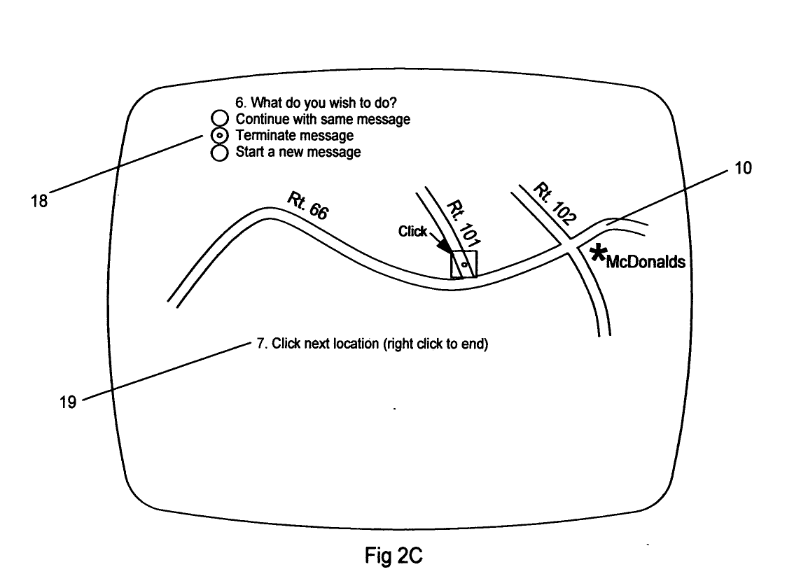

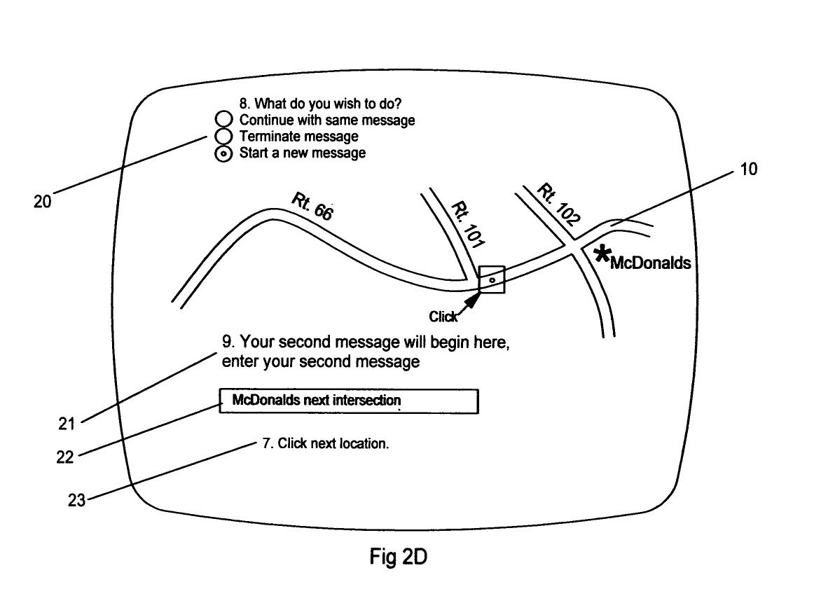

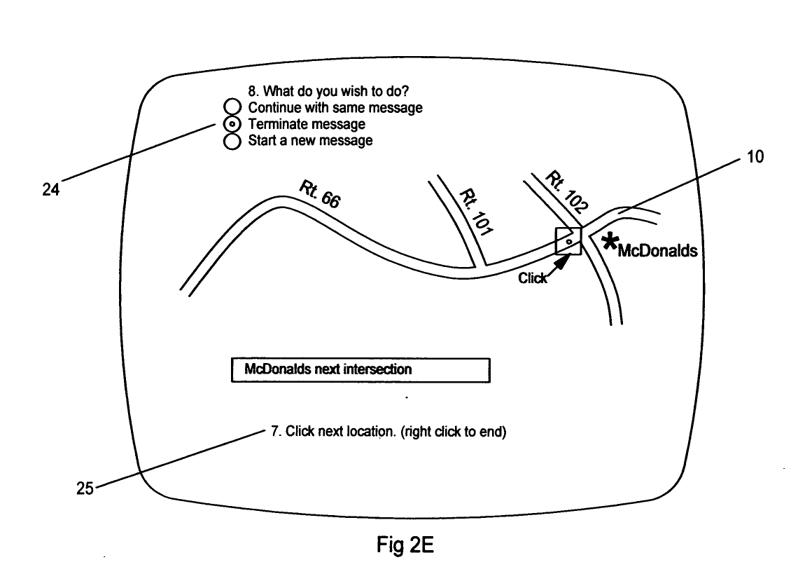

The next concept of the invention is the method by which the advertiser specifies his advertising message and the sequence in which the messages are to be displayed. This method is described as follows: Referring to FIG. 2A, the advertiser accesses a web page after passing security measures such as giving a password etc. The web page shows a map. The advertiser zooms in on the map 10 to the area of interest. A prompt instructs him “Click where you wish your first message to begin” He then clicks on the location 11 where he wishes his first message to begin. A prompt 12 instructs him “Your first message will begin here, please enter you message”. The advertiser then enters his message 13 “Watch for directions to McDonalds”. A prompt then instructs him “Click next location” The Advertiser then remembering that the mobile sign is a virtual billboard and one cannot see a billboard around a sharp curve then clicks on the road at the sharp curve as illustrated in FIG. 2B. Referring to FIG. 2B, a prompt 15 then instructs him “What do you wish to do? Continue with the same message, terminate the message or begin a new message” The advertiser then selects “Continue with the same message”. A prompt 16 instructs him “Click next location”. He then clicks at the location illustrated in FIG. 2C. He clicks on this location because he knows that if the truck with the mobile display turns onto Rt. 101 he wishes for the message to terminate. Another prompt 18 instructs him “What do you wish to do? Continue with the same message, terminate the message or begin a new message”. He then selects “terminate the message so that if the truck turns, the message will be terminated.

Prompt 19 then instructs him to “Click next location (right click to end)”. He then clicks at the location indicated in FIG. 2D. Prompt 20 again asked “What do you wish to do? Continue with the same message, terminate the message or begin a new message”. He now selects “Begin a new message”. A prompt 21 instructs “Your second message will begin here, enter your second message” He then enters his second message “McDonalds next intersection” 22. A prompt 23 then instructs him “Click next location”. He then clicks as indicated on FIG. 2E. Prompt 24 again asks “What do you wish to do? Continue with the same message, terminate the message or begin a new message”. He then selects “Terminate message”. Prompt 25 then instructs him “Click next location (right click to end)”. He decides that this is the end of his order for mobile advertising so he right clicks.

He would then be presented with an opportunity to add constraints such as time of day for the message to be displayed etc. followed by an opportunity to edit the work and other features of good web page design.

The above method therefore provides a clear and simple way for the advertiser to specify his advertising messages and the sequence in which they are to be displayed. The web page would not have to operate in the exact manner in which it was described above to fall within the spirit and scope of the invention. However the concept of specifying on a map the sequence messages are to be displayed is at the heart of the invention. The points on the map could be specified by means other than clicking. For instance a beginning location could be specified clicking and holding a mouse key down, dragging to a second location and the releasing the mouse button. The locations could be by other means such as specifying coordinates or using arrow keys to specify a location. The point is a location is specified. Note that the sequence of entering the begin location, the message to be displayed, and the end location could be entered in a different order from the order described in the preferred embodiment illustrated above and still fall within the spirit of the invention.

As mentioned earlier, many parts of the system of the present invention are explained in the prior art, such as GPS positioning, cell phone communications, computer processing, data storage etc. The details of the well known elements will not be further explained here, however it is essential to understand the parts of the present invention that are unique. Referring again to FIG. 1, an advertiser specifies his message and message sequence as described above on web page 1. This information is communicated to the server 3 via communications link 2. The server arranges the information into information packets and communicates the information via communications link 4 to the display 5. The communications link may be a cell phone connection. The display also contains a GPS that monitors the location of the display 5. The location of the mobile display unit could also be determined by the location of the cell phone tower through which it is communicating. Other methods of determining location are disclosed in the prior art and could be used by the present invention.

Next, the display with its incorporated communications, location determining device, and computing capabilities must determine whether a message is to be displayed. For example, an advertiser has selected a location where a first message will begin and a location where the first message will terminate or be continued. A distance ‘d’ is specified. When (and if) the display arrives within radius ‘d’ of the begin location, the distance ‘a’ from the mobile sign to the location where the first message will terminate or be continued is computed. When (and in the display arrives at the begin location, the distance ‘b’ between the sign and the location where the first message will terminate or be continued is again computed. If distance ‘b’ is less than distance ‘a’ then the advertiser's message is displayed, otherwise the message is not displayed.

The above discussion refers to the display arriving at a begin location and a location where the first message will terminate or be continued. There are, or may be errors in the GPS locating device or errors in specifying the exact locations messages are to be displayed. To overcome the effects of these errors, the locating device will determine if the display is in the vicinity of these locations. If the display is within a specified radius of a location then the display will be considered to be in the vicinity of the specified location and the above computations will be made as if it were at the specified location. An alternative way of determining if the display is in the vicinity of a specified location is to determine if the latitude and longitude of the display are within some error amount of the specified latitude and longitude of the specified location. Referring to FIG. 2A the box illustrated where the click 11 occurred represents the vicinity of the begin location. In the alternative, a circle could have been used to display the vicinity of click 11. Thus when location is specified it is understood that the location is not an exact point but is a location in the vicinity of the specified location.

Other variations of the above selection method are possible. Locations could be specified in a different order than illustrated in the preferred embodiment. Or the message could be displayed for a specified amount of time after the display arrives at the begin location. Another example would be to terminate the message after the mobile display has traveled a specified distance. Alternatively, the message could be terminated after the message has been displayed a specified amount of time or the mobile display has traveled a specified distance, whichever comes first. When referring to a specified time or distance it is understood that the time or distance could be computed as opposed to directly entered by the advertiser.

The claims refer to a computer terminal. The term computer terminal is intended to refer to the visual display of a computer whether it is the display associated with a terminal or the display associated with a computer or other type of human interface. The claims refer to “operations”. The word “operations” is used instead of “steps” because “steps” may carry a connotation of a specific sequence. The operations of the claims are not required to be in a specific sequence.

Although the present invention has been described with respect to a specific preferred embodiment thereof, various changes and modifications may be suggested by one skilled in the art and it is intended that the present invention encompass such changes and modifications as fall within the scope of the appended claims.

1. A method for selecting a message to be displayed on a message display equipped with a location detector mounted on a vehicle for travel on a highway, the method comprising the following steps:
providing a message display and a location detector and mounting the message display and the location detector onto a vehicle, wherein the vehicle is configured to travel on a highway;
designating a message for possible display on said message display;
selecting a location 1 on said highway;
selecting a location 2 on said highway;
monitoring the location of said message display;
displaying said message on said message display only if said location of said message display arrives at said location 1 before arriving at said location 2.

2. The message selection method of claim 1 wherein said message is terminated if said mobile display arrives at said location 2.

3. The message selection method of claim 1 wherein said message is continued if said mobile display arrives at said location 2.

4. The message selection method of claim 1 wherein a time interval is specified and said message is terminated after message has been displayed for said time interval.

5. The message selection method of claim 1 wherein a distance is specified and said message is terminated after said mobile display has traveled said distance.

6. A method for selecting a message to be displayed on a message display display equipped with a location detector mounted on a vehicle for travel on a highway, the method comprising the following steps:
providing a message display and a location detector and mounting the message display and the location detector onto a vehicle, wherein the vehicle is configured to travel on a highway;
designating a message for possible display on said message display;
selecting a location 1 on said highway;
selecting a location 2 on said highway;
specifying a distance ‘d’;
monitoring the location of said message display;
determining a distance ‘a’ from the message display to said location 2 when the mobile display arrives at the distance ‘d’ from said location 1;
determining a distance ‘b’ from the mobile display to said location 2 when the mobile display arrives at location 1;
displaying said message only if said location of said message display arrives at said location 1 and distance ‘a’ is greater then distance ‘b’.

7. The message selection method of claim 6 wherein said message is terminated if said mobile display arrives at said location 2.

8. The message selection method of claim 6 wherein said message is continued if said mobile display arrives at said location 2.

9. The message selection method of claim 6 wherein a time interval is specified and said message is terminated after message has been displayed for said time interval.

10. The message selection method of claim 6 wherein a distance is specified and said message is terminated after said mobile display has traveled said distance.

11. A method for selecting a message to be displayed on a message display equipped with a location detector mounted on a vehicle for travel on a highway, the method comprising the following steps:
providing a message display and a location detector and mounting the message display and the location detector onto a vehicle, wherein the vehicle is configured to travel on a highway;
providing a computer display:
presenting a map on said computer terminal;
selecting a begin location on said map;
selecting a location 2 on said map;
specifying a message for possible display on said mobile display;
displaying said message on said mobile display only if said mobile display arrives at said start location before arriving at said location 2.

12. The method of claim 11 wherein said location 2 is specified to be a location where said message is to be terminated.

13. The method of claim 11 wherein said location 2 is specified to be a location where said message is to be continued.

14. In the method of claim 11;
providing a computer mouse;
selecting said begin location by clicking on said map.

15. In the method of claim 11;
providing a computer mouse;
selecting said location 2 by clicking on said map.
